(19) United States
(12) Patent Application Publication
(10) Pub. No.: US 2015/0015390 A1
(43) Pub. Date: Jan. 15, 2015

(54) METHOD AND DEVICES FOR WRITING AN IDENTIFIER TO A TIRE PRESSURE MONITORING SENSOR

(71) Applicant: Continental Automotive Systems, Inc., Auburn Hills, MI (US)

(72) Inventors: Matthew D. McIntyre, New Baltimore, MI (US); Jean-Chrstophe Deniau, Fenton, MI (US); Brian J. Farrell, Troy, MI (US)

(21) Appl. No.: 13/942,247

(22) Filed: Jul. 15, 2013

(51) Int. Cl. B60C 23/04

(52) U.S. Cl. CPC B60C 23/0433
USPC 340/447

(57) ABSTRACT

The present invention relates to methods, systems and devices for integration of a tire pressure monitoring sensor with a tire pressure monitoring system of a vehicle. In one aspect, the present invention provides a method of integrating one or more tire pressure monitoring sensors with a tire pressure monitoring system of a vehicle. The method includes transmitting an identifier from a configuration tool to a first tire pressure monitoring sensor, wherein the first tire pressure monitoring sensor records the identifier on a memory device.

### CROSS-REFERENCE TO RELATED APPLICATION

The present application is related to commonly owned U.S. Non-provisional patent application titled: METHODS, SYSTEMS AND DEVICES FOR RECORDING AND TRANSMITTING IDENTIFICATION INFORMATION OF TIRE PRESSURE MONITORING SENSORS TO A VEHICLE, filed simultaneously to the present application, Docket No. 2012P01420US, and U.S. Non-provisional patent application titled: METHODS, SYSTEMS AND DEVICES FOR RECORDING AND TRANSMITTING IDENTIFICATION INFORMATION OF TIRE PRESSURE MONITORING SENSORS TO A VEHICLE, filed simultaneously to the present application, Docket No. 2012P01422US, the contents of both are hereby incorporated by reference in their entirety for all purposes.

### TECHNICAL FIELD

The present invention relates to methods, systems and devices for integration of a tire pressure monitoring sensor with a tire pressure monitoring system of a vehicle.

### BACKGROUND

Commercial and non-commercial vehicles now have tire pressure monitoring systems (TPMS) which include a central module, integrated or in communication with an electronic control unit of the vehicle, and tire pressure monitoring sensors (TPM sensors) for each vehicle wheel unit. In general, the TPM sensors monitor tire pressure within a respective tire and transmit a wireless signal to the central module which at a minimum includes tire pressure data. Should the sensed pressure be outside of an acceptable range or a substantial change in tire pressure occur, an alarm is generated and transmitted to the user of the vehicle.

Over time, TPM sensors require replacement by service technicians due to damage, depleted battery or otherwise. This requires installation and integration of new TPM sensors with a TPMS of a vehicle. During this process, in one configuration, the technician places the TPMS receiver of the vehicle in a learning mode and triggers each TPM sensor for identification purposes. The technician then sequentially triggers each TPM sensor utilizing a TPMS configuration tool, causing each sensor, new or existing, to transmit a wireless signal including an identifier to a control module of the TPMS. These tools communicate with a sensor through low frequency signals which in turn communicate with the TPMS through a higher frequency radio signal. The control module records the identifier, which may comprise numbers, letters, a combination of numbers and letters or any other identifying indicator, of each signal so as to interpret the location of TPM sensor data during operation thereof.

In a learning process of a typical TPMS, a technician places the TPMS receiver of the vehicle in learning mode by performing one or more steps, such as cycling an ignition key, pressing remote buttons, depressing a brake pedal, utilizing door lock switches, utilizing headlight switches, combinations thereof, or otherwise. As should be appreciated, this can be a laborious task. Once the learning processes is initiated, the TPMS tool indicates which tire pressure monitoring sensor installed on the vehicle should be triggered. The service technician moves to the specified wheel unit and utilizes the TPMS configuration tool to cause a corresponding TPM sensor to transmit a signal including an identifier. Once the signal is received by the control module, the control module confirms the learning of the TPM senor by either an audible signal or visual signal. The TPMS tool also receives the sensor data and indicates which TPM sensor is to be triggered next. This continues until all of the TPM sensors have been sequentially triggered, which requires the technician to walk to each wheel unit and place the tool next to a corresponding TPM sensor so as to trigger the sensor.

### SUMMARY

The present approaches provide methods, systems and devices for integration of a tire pressure monitoring sensor with a tire pressure monitoring system of a vehicle. The features of the present invention are predicated, in part, on use of a configuration tool configured for transmitting an existing tire pressure monitoring sensor identifier to a new tire pressure monitoring sensor, the new tire pressure monitoring sensor being configured to receive, store and retransmit the existing tire pressure monitoring sensor identifier.

Using the present approaches, it is no longer necessary to undergo timely, and at times, complicated learning processes for newly installed tire pressure monitoring sensors because the newly installed sensor will have and transmit the identifier of the previously installed tire pressure monitoring sensor, for a particular wheel unit of a vehicle.

In view of the foregoing, in a first aspect, a method of integrating one or more tire pressure monitoring sensors with a tire pressure monitoring system of a vehicle is provided. The method includes transmitting an identifier from a configuration tool to a first tire pressure monitoring sensor, wherein the first tire pressure monitoring sensor records the identifier on a memory device.

In another aspect, a configuration tool for communication with a tire pressure monitoring system is provided. The configuration tool includes a transmitter and receiver for communicating with tire pressure monitoring sensors. The configuration tool also includes a memory device for storing an identifier for a tire pressure monitoring sensor. The configuration tool further includes software instructions configured to transmit an identifier stored on the memory device to a tire pressure monitoring sensor through the transmitter.

In another aspect, a computer-readable memory device storing computer program instructions is provided. Which, when executed by a computer comprising at least one processor, the result is: i) the transmission of a signal suitable for causing a first tire pressure monitoring sensor to transmit a response signal; ii) the storing of an identifier included with the response signal into a memory device; and iii) the transmitting the stored identifier to a second tire pressure monitoring sensor.

In another aspect, a tire pressure monitoring sensor is provided. The tire pressure monitoring sensor includes a pressure sensor configured for monitoring air pressure and generating signals indicative thereof. The tire pressure monitoring sensor further includes a receiver configured for receiving wireless signals from a configuration tool. The tire pressure monitoring sensor further includes a processing unit and memory device including suitable software for: i) evaluating a signal received by the receiver to determine if an identifier is include within the signal, and ii) storing an identifier transmitted with the signal in a memory device of the tire pressure monitoring sensor. The tire pressure monitoring sensor further includes a wireless transmitter configured to transmit the stored identifier to a tire pressure monitoring system of a vehicle.

In another aspect, a method of monitoring and recording air pressure within a tire and transmitting the recorded air pressure and an identifier to a tire pressure monitoring system of a vehicle is provided. The method includes providing a tire pressure monitoring sensor including a pressure sensor, a processor, a memory device, a wireless receiver and a transmitter. The method further includes recording on the memory device an identifier received by the wireless receiver. The method further includes transmitting a wireless signal, including the recorded identifier and pressure data from the pressure sensor, through the wireless transmitter.

These and other features can be best understood from the following specification and drawings, the following of which is a brief description.

### BRIEF DESCRIPTION OF THE DRAWINGS

FIG. 1 illustrates a schematic view of an exemplary TPM sensor integration system for integration of a tire pressure monitoring sensor with a tire pressure monitoring system according to various embodiments of the present invention.

FIG. 2 illustrates a top view of an exemplary configuration tool for a tire pressure monitoring sensor according to various embodiments of the present invention.

FIG. 3 illustrates a schematic view of an exemplary configuration tool for a tire pressure monitoring sensor according to various embodiments of the present invention.

FIGS. 4A-4C illustrate a plurality of screenshots of a configuration tool during a recording process of a plurality of tire pressure monitoring sensors according to various embodiments of the present invention.

FIG. 5 illustrates a flow chart illustrating an exemplary method of integrating a tire pressure monitoring sensor with a tire pressure monitoring system according to various embodiments of the present invention.

FIG. 6 illustrates a top view of a tire pressure monitoring sensor including an integrated circuit according to various embodiments of the present invention.

### DETAILED DESCRIPTION

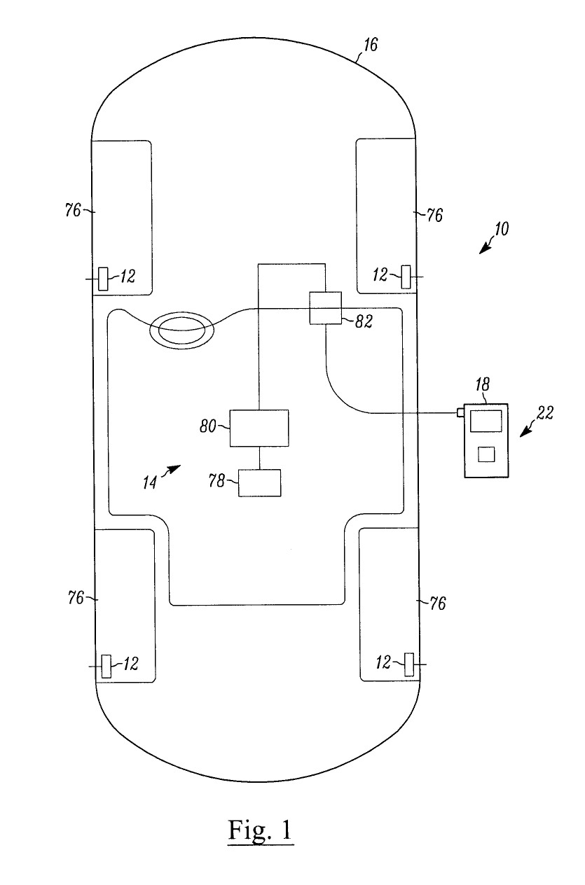

Referring to FIGS. 1 through 3, exemplary integration systems 10 for integration of a tire pressure monitoring (TPM) sensor 12 with a tire pressure monitoring system (TPMS) 14 of a vehicle 16 are shown. The integration systems 10 includes a configuration tool 18 for communication with a TPM sensor 12. The configuration tool 18 includes a transmitter 20 and receiver 21 for communication with the TPM sensor 12. The configuration tool 18 is configured with a user interface 22 and suitable software for generating and transmitting a signal to a TPM sensor and receiving and recording an identifier contained with a response signal from the TPM sensor. It should be appreciated that an identifier can comprise one or more numbers, letters, combinations of numbers and letters or otherwise. The suitable software and recorded identifier are stored on one or more computer-readable memory devices 24. The configuration tool 18 is further configured to transmit the recorded identifier to another TPM sensor where it is stored and accessible for retransmission.

In one exemplary mode of operation, a user utilizes the user interface 22 of the configuration tool 18 to cause a triggering signal to be transmitted to a first TPM sensor 12′, via transmitter 20. In response, the first TPM sensor 12′ generates a response signal, including an identifier of the first TPM sensor, that is received by the configuration tool 18, via receiver 21. The identifier received by the configuration tool 18 is displayed on a display screen 26 of the user interface 22 and stored on a computer-readable memory device 24 of the configuration tool. The user then utilizes the user interface 22 of the configuration tool 18 to transmit the stored identifier to a second TPM sensor 12″, via transmitter 20. The identifier is stored on the second TPM sensor 12″ and transmitted with each subsequent transmission.

As should be appreciated, with the copying and transfer of an existing TPM sensor identifier, the learning process which TPMS utilize to learn identifiers of TPM sensors can be avoided. The removal of this step allows a user to forego a learning process, which includes placement of a vehicle in a learning mode, which includes one or more steps, such as cycling an ignition key, pressing remote buttons, depressing a brake pedal, utilizing door lock switches, utilizing headlight switches, combinations thereof, or otherwise. It also eliminates steps necessary during a learning mode. For example, in a learning mode the TPMS 14 is configured to receive and interpret wireless data having a particular data format, e.g. frequency, rate of data transmission, order of data transmission, or otherwise, as prescribed by original equipment manufacturers of the TPMS or vehicle 16. The TPMS 14 is configured to receive a particular number of responses based upon the number of TPM sensors being utilized by the vehicle 16, e.g. 4. The TPMS is further configured to receive the responses in a particular order. As an example, once in the learning mode the TPMS 14 anticipates the receipt of a first wireless signal from a front passenger wheel unit, a second wireless signal from a rear passenger wheel unit, a third wireless signal from a rear driver wheel unit and the fourth wireless signal from a front driver wheel unit. Once received, the TPMS assigns a wheel position to an identifier transmitted with each wireless signal so as to identify the origination of each wireless signal received thereafter.

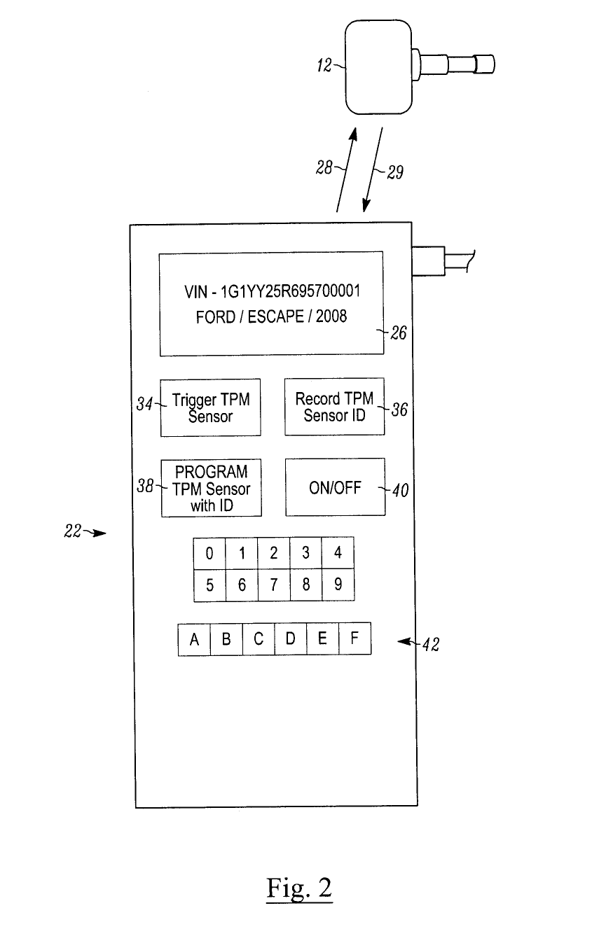

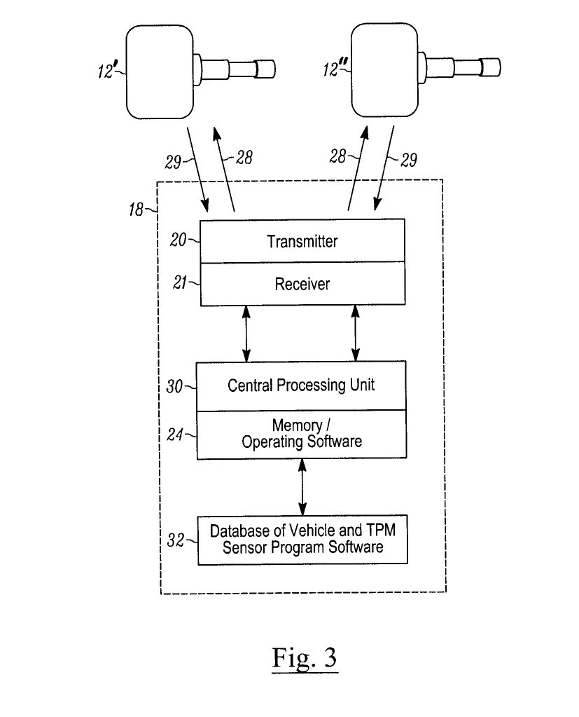

In greater detail, with reference to FIGS. 2 and 3, examples of the configuration tools 18 are shown. The configuration tools 18 includes transmitter 20 and receiver 21 for forming a first communication link 28 with the TPM sensor 12. In several examples, the first communication link 28 and second communication link 29 comprise a wireless communication links formed between the configuration tool 18 and the TPM sensor 12. In these embodiments, the transmitter 20 comprises a wireless transmitter and the receiver 21 comprises a wireless receiver. The transmitter 20 and receiver 21 are configured to send and receive signals suitable for communication with a TPM sensor 12. Accordingly, in one example, the transmitter 20 is configured to transmit low frequency signals and the receiver 21 is configured to receive high frequency signals. It should be appreciated that low frequency signals are commonly in the range of about 30 to 300 kHz and the high frequency signals are greater than about 300 MHz or in the range of about 300 MHz to 3 GHz.

Referring to FIG. 3, the configuration tool 18 further includes a suitable central processing unit 30 and a computer-readable memory device 24 for controlling various components of the configuration tool. The central processing unit 30 is configured for generating signals through the transmitter 20 and processing and/or storing signals received by the receiver 21 into the memory device, such as computer-readable memory device 24 or otherwise. The central processing unit 30 further executes operating instructions for the configuration tool 18 for communication with the various devices, generation and/or interaction with a user interface 22 of the configuration tool or otherwise.

In one example, the configuration tool 18 includes or is in communication with a database of vehicle and TPM sensor program software 32 for configuring and/or programming of a TPM sensor 12. In this embodiment, the central processing unit 30 is adapted to configure or program a TPM sensor 12 with suitable program software for interacting with a particular TPMS of a particular vehicle. Such programming can include communication protocols, operation instructions, or otherwise, for the TPM sensor.

Referring to FIG. 2, the configuration tool 18 includes user interface 22 for facilitating in operation of the configuration tool including initiating commands of configuration tool operation software stored on the computer-readable memory device 24. In one example, the user interface 22 comprises display screen 26 and buttons 34, 36, 38 and 40 for initiating operation commands. For example, in one example, the display screen 26 displays information received from the TPM sensor 12. In another example, the display screen 26 displays information pertaining to programming or configuration of a TPM sensor for integration with a TPMS 14 of a vehicle 16. For example, in one configuration the display screen 26 indicates an identifier of the TPM sensor, vehicle make, model and/or year of manufacture, which the TPM sensor was or is to be mounted to, wheel unit position, which the TPM sensor was or is to be mounted to, tire data recorded by a TPM sensor, TPM sensor configuration information, TPM sensor programming information, TPM sensor make, model and/or year of manufacturer, or otherwise.

In one example, the user interface 22 further includes a keypad for manually entering an identifier of the previously installed TPM sensor 12. This is particularly advantageous when the TPM sensor 12 is non-functional or has a dead battery. The keypad 42 is in communication with the processing unit 30 of the programming tool 18. In this particular configuration, the keypad 42 is integrated with the programming tool 18. However, in an alternate configuration, the keypad 42 comprises a separate component that is in communication with the programming tool 18 through a wired or wireless connection.

In another example, as shown in FIG. 1, the configuration tool 18 includes a on-board diagnostic connector 82 for downloading the identifiers of one or more TPM sensors 12. Once the identifier(s) are downloaded, they are assigned to a wheel unit position. The identifier(s) are then transmitted and installed onto a memory device of a new TPM sensor, based upon the wheel unit it is replacing.

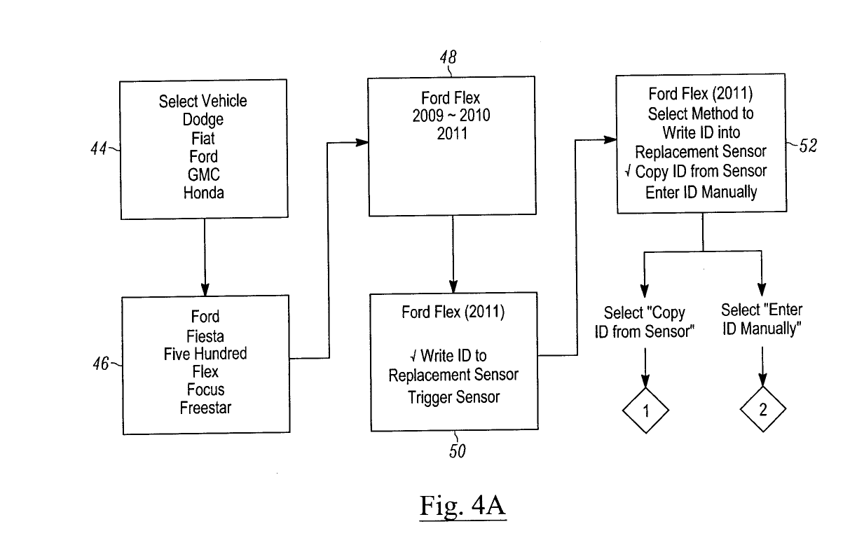

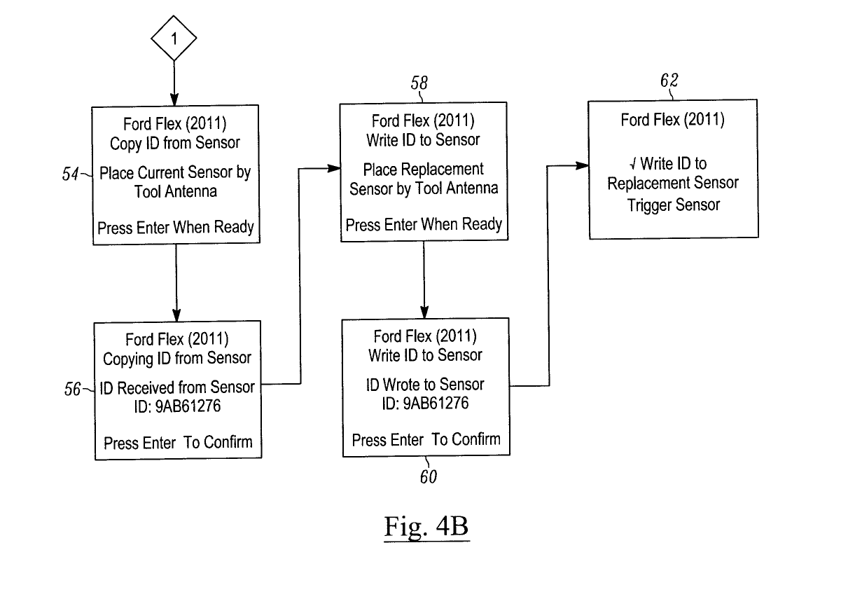

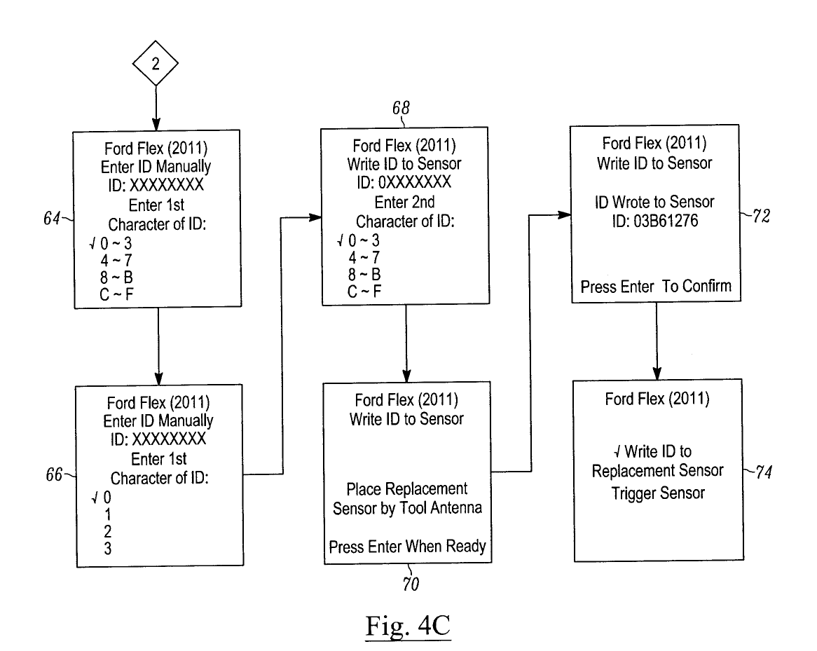

In one example, referring to FIGS. 4A-4C, the display screen 26 displays various information for view or selection during configuration or programming of a TPM sensor 12. The configuration tool 18 includes a touch screen and/or scroll buttons for selection and manipulation through the various screens. For example, in a first screenshot 44, the display screen 26 lists the vehicle make to which a TPM sensor 12 is to be programmed or configured for. In a second screenshot 46, the display screen 26 lists the models of the selected vehicle make. In a third screenshot 48, the display screen 26 lists years of manufacture of the selected vehicle make and model. In a fourth screenshot 50, the display screen 26 provides the option to write an identifier to a TPM sensor or trigger a TPM sensor for the selected vehicle make, model and year. In a fifth screenshot 52, the display screen 26 provides the ability to copy an identifier from a TPM sensor or manually input the identifier of the TPM sensor into the configuration tool 18.

Screenshots 54 though 62 depict screens during a copy process of an identifier from a TPM sensor and screenshots 64 through 74 depict screens during a manually input process of an identifier.

With respect to copying process of an identifier from a TPM sensor, in a sixth screenshot 54, the user is directed to place a TPM sensor proximate the configuration tool 18 and press a suitable button for triggering the TPM sensor to generate a signal. In a seventh screen shot 56, the configuration tool generates the identifier received from the TPM sensor and request confirmation of the identifier. In an eighth screen shot 58, the configuration tool instructs the user to place a replacement TPM sensor proximate the configuration tool and press a suitable button when ready. In a ninth screen shot 60, the display screen 26 indicates whether to write the identifier to the replacement TPM sensor and request confirmation. In a tenth screen shot 62, the display screen confirms that the identifier has been written to the TPM sensor and offers the ability to trigger the replacement TPM sensor.

With respect to manually inputting process of an identifier for a TPM sensor, in a eleventh screen shot 64, the display screen provides the ability to select different series of characters for selection and input for a first character of an identifier. In a twelfth screen shot 66, the display screen 26 provides the ability to select a particular character from a particular series of characters for entry as a first character of the identifier. In a thirteenth screen shot 68, the display screen 26 provides the ability to repeat the process for a second character of the identifier. In a fourteenth screen shot 70, the configuration tool instructs the user to place a replacement TPM sensor proximate the configuration tool and press a suitable button when ready. In a fifteenth screen shot 72, the display screen 26 indicates weather to write the identifier to the replacement TPM sensor and request confirmation. In a sixteenth screen shot 74, the display screen confirms that the identifier has been written to the TPM sensor and offers the ability to trigger the replacement TPM sensor.

Referring again to FIG. 2, alternatively or in conjunction with the screenshots, the user interface 22 includes buttons 34-40 for performing similar and/or additional functions to that of the screenshots. For example, in one example, the configuration tool 18 includes a Trigger TPM Sensor button 34 which initiates the transmission of a trigger signal through the transmitter 20. As previously indicated, the display screen 26 displays the response transmission from the TPM sensor including the TPM sensor identifier. The user interface 22 further includes a Record TPM Sensor ID button 36 for recording a received or manually inputted identifier, as shown on the display screen 26. The user interface 22 further includes a Program TPM Sensor with ID button 38 which initiates transmission of the recorded identifier to a replacement TPM sensor, which in one example further includes transmission of program software for the TPM sensor. The user interface 22 further includes an On/Off button 40. It should be appreciated that more or less buttons may be used, in view of the teachings herein, and may be configured to act with the screenshots described with FIGS. 4A-4C.

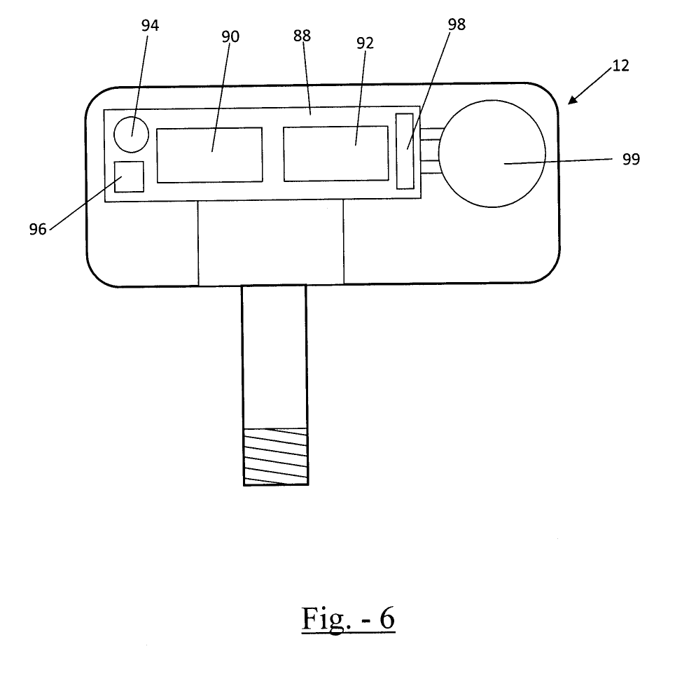

Referring to FIG. 6, an exemplary TPM sensor 12 is shown. The TPM sensor 12 includes an integrated circuit board 88 including a processing unit 90, one or more computer-readable memory device 92, pressure sensor 94, receiver 96 and wireless transmitter 98. The TPM sensor 12 further includes a suitable power supply, such as battery 99, for providing power to various components of the integrated circuit board 88 including processing unit 90, wireless transmitter 98 or otherwise. The pressure sensor 94 of the TPM sensor 12 generates raw data indicative of air pressure within the associated tire. The raw data is transmitted to the processing unit 90 and stored on the computer-readable memory device 92 of the TPM sensor 12. In one example, the memory device 92 further stores the unique identifier for the TPM sensor 12.

The wireless transmitter 98 transmits low frequency signals such as low frequency signals in the range of about 30 to 300 kHz. In one example, transmitter 98 transmits high frequency signals such as signals commonly transmitted by TPM sensors 12 such as signals greater than about 300 MHz or in the range of about 300 MHz to 3 GHz, such as between about 315 to 433 MHz and in certain particular configurations around 315 MHz, around 433 MHz or higher.

The receiver 96 is configured for receiving wireless signals from the configuration tool 18 including an identifier. The signals received by the receiver 96 are transmitted to the processing unit 90 where it is evaluated in part through suitable software stored on the computer-readable memory device 92. Should the signal be interpreted to include an identifier then the processing unit 90 stores the identifier on the computer-readable memory device 92 or other memory device of the TPM sensor 12. Evaluation and selection of an identifier can be performed in different manners. In one example, the processing unit 90 and software stored on the computer-readable memory device 92 monitors for a particular code or other indicator that indicates that some or all of the information within the signal comprises an identifier to be utilized by the TPM sensor 12. For example, should a portion of the signal include a certain code, e.g. binary or otherwise, representative of an identifier, then the TPM sensor knows, through suitable software stored on the computer-readable memory device 92, to store the identifier included with the signal. The signal can be stored on the computer-readable memory device 92 or other memory device and subsequently transmitted with signals intended for receipt by a TPMS of a vehicle. Such signal would also include tire pressure data and/or other data commonly transmitted by a TPM sensor. In one example, the signal received by the TPM sensor 12 includes the identifier along with a configuration instructions for configuring operation of the TPM sensor 12 including transmission and data configuration protocols, program software including operating instruction for the TPM sensor, or both configuration instructions and program software.

In one example, the configuration tool 18 includes or is in communication with a database of program software and/or configuration data for programming and/or configuring of a TPM sensor 12. In this example, a central processing unit of the configuration tool 18 is adapted to program and/or configure a TPM sensor with suitable program software for interacting with a particular TPMS of a particular vehicle. The program software may include a single piece of code or multiple pieces of code. Such software or pieces of code can include communication protocols such as transmission frequency, data format or otherwise. Such software or pieces of code can alternatively include operation instructions for function of the TPM sensor. Still further, the software or pieces of code can include a combination of communication protocols and operation instruction, or otherwise.

In one example, the operating instructions includes a single software program (or routine) or multiple software programs (or routines or subroutines) for causing the sensor to operate, which may be according to original manufacturers specification for a TPM sensor or a tire pressure monitoring system. For example, it is contemplated that the one or more software programs causes: i) tire pressure to be measured, ii) temperature of air within a tire to be measured, iii) tire pressure data to be calibrated based upon temperature, iv) a signal to be generated and transmitted according to original manufacturers specification, v) analysis of signals received by a receiver of the TPM sensor, vi) generation of a response signal to a signal received by a receiver of the TPM sensor, vii) formation of communication protocols (such as data structure, computer instructions or otherwise., viii) combinations thereof, or ix) otherwise. In one example, once the TPM sensor is programmed with the program software the program software becomes permanently, or semi-permanently, embedded within a memory device of the TPM sensor to prevent change or substantial change of the program software.

In one example, the protocol comprises data structure of signals being generated and analyzed by the TPM sensor. The protocol can be implemented by program software received by or existing within a memory device the TPM sensor. The protocol may be automatically implemented when received by the TPM sensor, the protocol may include instruction for implementation, or otherwise. By example, the protocol may include one or more of: i) data structure, ii) computer instructions, iii) transmission frequency, iv) data frames per transmission, v) time periods between transmission, or vi) otherwise. In one particular example, the transmission received by the TPM sensor includes an indication that the signal comprises a protocol signal and includes communication protocol for the TPM sensor to operate, includes the data structure of signals to be generated including placement of wakeup signals, pressure data, temperature data, and/or otherwise. The signal also indicates frequency of transmission and number of frames to be transmitted per transmission, wherein each frame includes wakeup signal, pressure data, temperature data and/or otherwise. The protocol signal also indicates time periods between transmission. It should be appreciated that other communication protocols and configurations can be included.

The program software can vary based upon the vehicle make, model and/or year of manufacture. Alternatively, the program software can be configured for multiple applications, e.g. multiple vehicle makes, models and/or years of manufacture. As such, programming of the TPM sensor can include transfer of multiple communication protocols and/or operation instructions for multiple tire pressure monitoring systems. Also, programming or configuration of the TPM sensor can include selection of communication protocols and/or operation instruction from a database located with the TPM sensor.

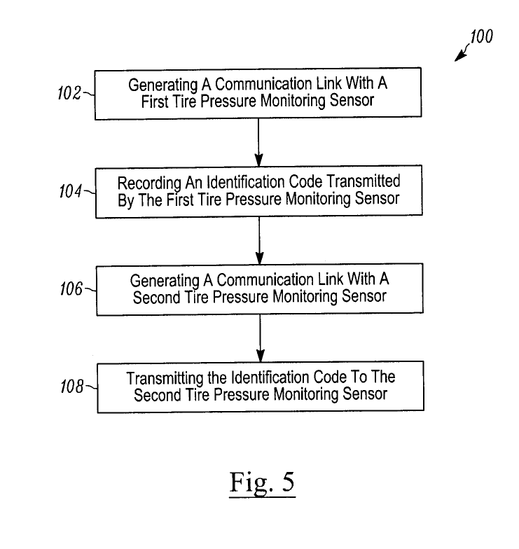

Referring to FIG. 5, the present invention further contemplates methods 100 of integrating TPM sensors 12 with a TPMS 14 of a vehicle. The method includes step 102 of utilizing the configuration tool 18 to generate a communication link with a first TPM sensor 12′. In one example, this is achieved by pressing the Trigger TPM Sensor button 34 which interacts with the central processing unit 30 to transmit a triggering signal to an existing TPM sensor through the transmitter 20. As previously mentioned, in an alternate configuration the identifier is manually entered into the configuration tool 18 through the user interface, in particular the display screen 26 and/or keypad 42.

The method further includes the step 104 of recording an identifier transmitted by the existing TPM sensor in response to the triggering signal. In one example, the response signal is received by the receiver 21 and stored in the computer-readable memory device 24 by the central processing unit 30.

The method further includes the step 106 of utilizing the configuration tool 18 to generate a communication link with a second TPM sensor 12″. In one example, this is achieved by pressing the Program TPM Sensor with ID button 38 which interacts with the central processing unit 30 to transmit the recorded identifier to the new TPM sensor through the transmitter 20. In one example, the identifier is transmitted with program software for the TPM Sensor. Once the identifiers are transferred to the replacement TPM sensor, the sensor is triggered causing the sensor to transmit a signal that is received by a control module 78 of the TPMS 14 and electronic control unit 80 of the vehicle 16. This process is repeated for each wheel unit 76 of the vehicle 16 having the TPM sensor 12 replaced. It should be appreciated that more or less steps may be included in the methods of the present invention, as shown and described herein.

While the invention has been described with reference to a preferred embodiment it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of integrating one or more tire pressure monitoring sensors with a tire pressure monitoring system of a vehicle, the method comprising:
transmitting an identifier from a configuration tool to a first tire pressure monitoring sensor,
wherein the first tire pressure monitoring sensor records the identifier on a memory device.

2. The method of claim 1, wherein a wireless communication link is formed between the first tire pressure monitoring sensor and the configuration tool.

3. The method of claim 2, wherein the communication link formed between the first tire pressure monitoring sensor and the configuration tool comprises a low frequency communication link in the range of between about 30 to 300 kHz.

4. The method of claim 1, further comprising the step of manually entering the identifier into a user interface of the configuration tool prior to transmission of the identifier to the first tire pressure monitoring sensor.

5. The method of claim 1, further comprising:
generating a communication link between a second tire pressure monitoring sensor and the configuration tool for a tire pressure monitoring sensor;
utilizing the configuration tool to cause the second tire pressure monitoring sensor to generate a signal including an identifier; and
recording the identifier of the second tire pressure monitoring sensor on a memory device of the configuration tool.

6. The method of claim 5, wherein the identifier transmitted to the first tire pressure monitoring sensor is the same as the identifier of the second tire pressure monitoring sensor.

7. The method of claim 5, wherein the communication link formed between the second tire pressure monitoring sensor and the configuration tool comprises a wireless communication link.

8. The method of claim 7, wherein the communication link formed between the second tire pressure monitoring sensor and the configuration tool comprises a low frequency communication link in the range of between about 30 to 300 kHz.

9. The method of claim 1, further comprising the step of programming the first tire pressure monitoring sensor with suitable program software.

10. The method of claim 9, wherein the identifier is transmitted to the first tire pressure monitoring sensor during programming of the first tire pressure monitoring sensor.

11. The method of claim 10, wherein the first sensor is configured for flash programming

12. A configuration tool for communication with a tire pressure monitoring system, comprising:
a transmitter for communicating with tire pressure monitoring sensors;
a memory device for storing an identifier for a tire pressure monitoring sensor; and
software instructions configured to transmit the identifier stored on the memory device to a tire pressure monitoring sensor through the transmitter.

13. The tool of claim 12, further comprising a receiver for receiving signals transmitted by tire pressure monitoring sensors.

14. The tool of claim 13, wherein the software instructions are further configured to transmit a signal suitable for causing a tire pressure monitoring sensor to transmit a response signal including the identifier of the tire pressure monitoring sensor.

15. The tool of claim 14, wherein the software instructions are further configured to store an identifier of the response signal onto the memory device.

16. The tool of claim 12, wherein the transmitter comprise a low frequency wireless transmitter configured for transmitting wireless signals in the range of between about 30 to 300 kHz.

17. The tool of claim 12, wherein the receiver comprises a high frequency wireless receiver configured for receiving wireless signals greater than about 300 MHz.

18. The tool of claim 12, further comprising a user interface for inputting the identifier of a tire pressure monitoring sensor.

19. The tool of claim 12, further comprising a database of program software for tire pressure monitoring sensors.

20. A computer-readable memory device storing computer program instructions which when executed by a computer comprising at least one processor results in:
transmission of a signal suitable for causing a first tire pressure monitoring sensor to transmit a response signal;
storing of an identifier included with the response signal into a memory device; and
transmitting the stored identifier to a second tire pressure monitoring sensor.

21. The computer-readable memory device of claim 20, wherein the signal transmitted to the first and second tire pressure monitoring sensors comprise low frequency wireless signals in the range of between about 30 to 300 kHz.

22. A tire pressure monitoring sensor, comprising:
a pressure sensor configured for monitoring air pressure and generating signals indicative thereof;
a receiver configured for receiving wireless signals from a configuration tool;
a processing unit and memory device including suitable software for:
evaluating a signal received by the receiver to determine if an identifier is include within the signal, and
storing an identifier transmitted with the signal in a memory device of the tire pressure monitoring sensor; and
a wireless transmitter configured to transmit the stored identifier to a tire pressure monitoring system of a vehicle for storage to a memory storage unit of the vehicle.

23. The tire pressure monitoring sensor of claim 22, wherein the identifier is representative of numbers, letters or a combination thereof.

24. The tire pressure monitoring sensor of claim 22, wherein the identifier is stored on the memory device having the suitable software.

25. The tire pressure monitoring sensor of claim 22, wherein the processing unit and memory device including suitable software evaluates the signal for an indication that a portion of the signal comprises the identifier.

26. The tire pressure monitoring sensor of claim 22, wherein the processing unit and memory device including suitable software evaluates the signal for an indication that the entire signal comprises the identifier.

26. The tire pressure monitoring sensor of claim 22, wherein the processing unit and memory device including suitable software differentiates between the identifier and configuration instructions for the tire pressure monitoring sensor.

27. The tire pressure monitoring sensor of claim 22, wherein the processing unit and memory device including suitable software differentiates between the identifier and program software for the tire pressure monitoring sensor.

28. A method of monitoring and recording air pressure within a tire and transmitting the recorded air pressure and an identifier to a tire pressure monitoring system of a vehicle, comprising:
providing a tire pressure monitoring sensor including a pressure sensor, a processor, a memory device, a wireless receiver and a transmitter;
recording on the memory device an identifier received by the wireless receiver; and
transmitting a wireless signal, including the recorded identifier and pressure data from the pressure sensor, through the wireless transmitter.

29. The method of claim 28, wherein the wireless receiver receives low frequency signals in the range of between about 30 to 300 kHz.

30. The method of claim 28, wherein the transmitter transmits high frequency signals greater than about 300 MHz.

31. The method of claim 28, wherein the processing unit and the memory device, which includes suitable software instructions, evaluates signals received by the wireless receiver to determine if an identifier is included with the signal.

32. The method of claim 28, wherein the identifier is representative of numbers, letters or a combination thereof.
